(19) United States
(12) Patent Application Publication
(10) Pub. No.: US 2026/0343413 A1
(43) Pub. Date: Oct. 29, 2026

(54) METHOD AND APPARATUS FOR SENDING OR MONITORING DOWNLINK CONTROL INFORMATION, AND DEVICE AND MEDIUM

(71) Applicant: Beijing Xiaomi Mobile Software Co., Ltd., Beijing (CN)

(72) Inventors: Ting FU, Beijing (CN); Wei LIU, Beijing (CN)

(73) Assignee: Beijing Xiaomi Mobile Software Co., Ltd., Beijing (CN)

(21) Appl. No.: 19/113,462

(22) PCT Filed: Sep. 27, 2022
(86) PCT No.: PCT/CN2022/121844

§ 371 Date: Mar. 20, 2025

(51) Int. Cl. H04W 52/02; H04W 72/23; H04W 76/28

(52) U.S. Cl. CPC H04W 52/0235; H04W 72/23; H04W 76/28

(57) ABSTRACT

The present disclosure is applied in the technical field of wireless communications. Provided are a method and apparatus for sending or monitoring downlink control information, and a device and a readable storage medium. The method for monitoring downlink control information comprises: when it is determined that there is no downlink scheduling data transmission in an on duration in a connected discontinuous reception (C-DRX) mode, not monitoring a physical downlink control channel (PDCCH), and entering a sleep state and monitoring a low-power wake-up signal.

### CROSS-REFERENCE TO RELATED APPLICATIONS

The application is a U.S. National Stage of International Application No. PCT/CN 2022/121844 filed on Sep. 27, 2022, the entire content of which is incorporated herein by reference.

### TECHNICAL FIELD

The present disclosure relates to the technical field of wireless communication, and more particularly, to a method and an apparatus for sending and monitoring downlink control information, a device, and a readable storage medium.

### BACKGROUND

In the new radio (NR) of the 5th generation mobile networks (5G), in order to save unnecessary power consumption of a terminal device, a discontinuous reception (DRX) mechanism is applied to assist a user equipment in a radio resource control (RRC) connected state to save energy.

As shown in FIG. 1, a basic mechanism of connected discontinuous reception (C-DRX) is to configure a DRX cycle for the UE in the RRC connected state. The DRX cycle consists of an “on duration” and an “off duration”. During the on duration, the user equipment may monitor and receive a Physical Downlink Control Channel (PDCCH), and during the off duration, it does not monitor the PDCCH to reduce power consumption.

### SUMMARY

The present disclosure provides a method and an apparatus for sending or monitoring downlink control information, and a device, and a readable storage medium.

According to a first aspect, there is provided a method for monitoring downlink control information, performed by a user equipment, the method including: when determining that no downlink scheduling data transmission exists in an on duration in a connected discontinuous reception (C-DRX) mode, not monitoring a physical downlink control channel (PDCCH), and entering a sleep state and monitoring a low-power wake-up signal.

In a second aspect, there is provided a method for sending downlink control information, performed by a network device, the method including:

during an on duration in a connected discontinuous reception (C-DRX) mode, sending scheduling data through a physical downlink control channel (PDCCH) after sending a low-power wake-up signal to a user equipment.

In a third aspect, there is provided an apparatus for monitoring downlink control information, configured for a user equipment, the apparatus including:

a transceiver module, configured to not monitor a physical downlink control channel (PDCCH) and monitor a low-power wake-up signal when it is determined that no downlink scheduling data transmission exists in an on duration in a connected discontinuous reception (C-DRX) mode; and

a processing module, configured to enter a sleep state when determining that no downlink scheduling data transmission exists in the on duration in the C-DRX mode.

In a fourth aspect, there is provided an apparatus for sending downlink control information, configured for a network device, the apparatus including:

a transceiver module, configured to, during an on duration in a connected discontinuous reception (C-DRX) mode, send scheduling data through a physical downlink control channel (PDCCH) after sending a low-power wake-up signal to a user equipment.

In a fifth aspect, there is provided an electronic device including a processor and a memory, where

the memory is configured to store a computer program; and

the processor is configured to execute the computer program to implement the first aspect or any one of the possible designs of the first aspect.

In a sixth aspect, there is provided an electronic device including a processor and a memory, where

the memory is configured to store a computer program; and

the processor is configured to execute the computer program to implement the second aspect or any one of the possible designs of the second aspect.

According to a seventh aspect, there is provided a computer-readable storage medium having instructions stored therein that, when called for execution on a computer, cause the computer to perform the above first aspect or any one of the possible designs of the first aspect.

According to an eighth aspect, there is provided a computer-readable storage medium having instructions stored therein that, when called for execution on a computer, cause the computer to perform the above second aspect or any one of the possible designs of the second aspect.

It should be understood that the above general description and the following detailed description are merely exemplary and explanatory, and do not limit the present disclosure.

### BRIEF DESCRIPTION OF THE DRAWINGS

The accompanying drawings described herein are used to provide a further understanding of the embodiments of the present disclosure and constitute a part of the present application, and the schematic embodiments of the embodiments of the present disclosure and the description thereof are used to explain the embodiments of the present disclosure, and do not constitute an undue limitation of the embodiments of the present disclosure. In the drawings:

The accompanying drawings herein, which are incorporated into and constitute a part of the specification, illustrate embodiments consistent with the embodiments of the present disclosure and, together with the specification, serve to explain the principles of the embodiments of the present disclosure.

FIG. 1 is a schematic diagram of a cycle in a C-DRX configuration provided by an embodiment of the present disclosure.

FIG. 2 is a schematic architecture diagram of a wireless communication system provided by an embodiment of the present disclosure.

FIG. 3 is a schematic diagram of sending and monitoring downlink control information provided by an embodiment of the present disclosure.

FIG. 4 is another schematic diagram of sending and monitoring downlink control information provided by an embodiment of the present disclosure.

FIG. 5 is a schematic diagram of monitoring downlink control information provided by an embodiment of the present disclosure.

FIG. 6 is another schematic diagram of monitoring downlink control information provided by an embodiment of the present disclosure.

FIG. 7 is another schematic diagram of monitoring downlink control information provided by an embodiment of the present disclosure.

FIG. 8 is another schematic diagram of monitoring downlink control information provided by an embodiment of the present disclosure.

FIG. 9 is a schematic diagram of sending downlink control information provided by an embodiment of the present disclosure.

FIG. 10 is a structural diagram of a user equipment provided by an embodiment of the present disclosure.

FIG. 11 is a structural diagram of another user equipment provided by an embodiment of the present disclosure.

FIG. 12 is a structural diagram of a network device provided by an embodiment of the present disclosure.

FIG. 13 is a structural diagram of another network device provided by an embodiment of the present disclosure.

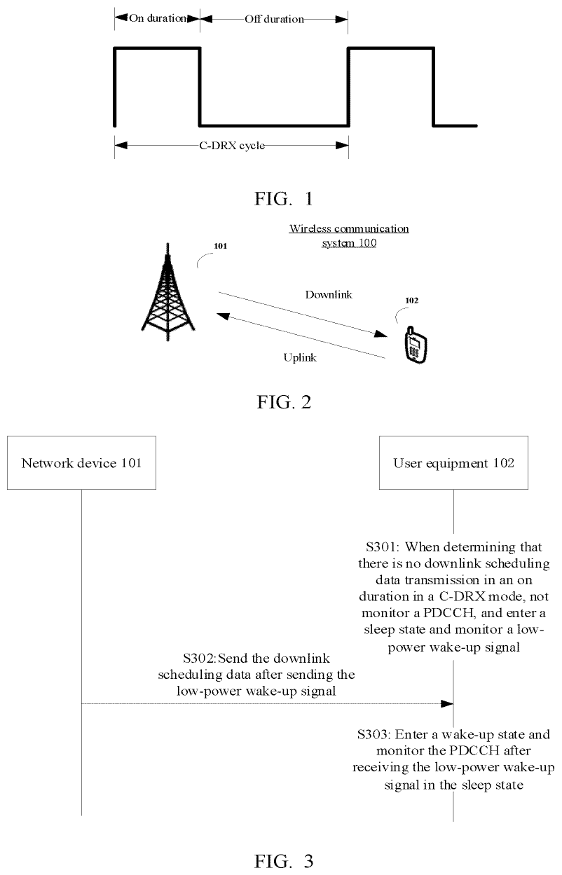

### DETAILED DESCRIPTION

Embodiments of the present disclosure will now be further described with reference to the accompanying drawings and detailed description.

Exemplary embodiments will be described in detail herein, examples of which are represented in the accompanying drawings. When the following description relates to the drawings, the same numerals in different accompanying drawings represent the same or similar elements unless otherwise indicated. The implementations described in the following exemplary embodiments do not represent all implementations consistent with the present disclosure. To the contrary, they are merely examples of apparatuses and methods that are consistent with some aspects of the present disclosure, as detailed in the appended claims.

Terms used in the present disclosure are used solely for the purpose of describing certain embodiments and are not intended to limit the present disclosure. The singular forms of “a/an”, “said” and “the” used in the embodiments of the present disclosure and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “when . . . ” or “in the case . . . ” or “in response to determination”.

Embodiments of the present disclosure are described in detail below, examples of which are illustrated in the accompanying drawings, in which the same or similar reference numerals denote the same or similar elements throughout. The embodiments described below with reference to the accompanying drawings are exemplary and are intended to be used to explain the present disclosure, and are not to be construed as limiting the present disclosure.

As shown in FIG. 2, a method for sending and monitoring downlink control information provided by an embodiment of the present disclosure may be applied to a wireless communication system 100, and the wireless communication system may include a user equipment 101 and a network device 102. Herein, the user equipment 101 is configured to support carrier aggregation and may be connected to a plurality of carrier units of the network device 102, which include one primary carrier unit and one or more secondary carrier units.

It should be understood that the above wireless communication system 100 may be adapted to both low frequency scenarios and high frequency scenarios. The application scenario of the wireless communication system 100 includes, but is not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-Generation (5G) system, a new radio (NR) communication system, or a future evolved public land mobile network (PLMN) system, etc.

The user equipment 101 shown above may be a user equipment (terminal), an access user equipment, a user equipment unit, a user equipment station, a mobile station (MS), a remote station, a remote user equipment, a mobile user equipment (mobile terminal), a wireless communication device, a user equipment agent, a user equipment, or the like. The user equipment 101 may have a wireless transceiver function, which is capable of communicating (for example, wireless communication) with one or more network devices of one or more communication systems, and receiving network services provided by the network devices, where the network device herein includes, but is not limited to, the illustrated network device 103.

The user equipment 101 may be a cellular telephone, a cordless telephone, a session initiation protocol (SIP) telephone, a wireless local loop (WLL) station, a personal digital assistant (PDA) device, a handheld device having a wireless communication function, a computing device or other processing device connected to a wireless modem, a vehicle-mounted device, a wearable device, a user equipment in a future 5G network or a future evolved PLMN network, or the like.

The network device 102 may be an access network device (or access network station). The access network device refers to a device that provides network access functions, such as a radio access network (RAN) base station, etc. The network device 103 may specifically include a base station (BS), or include a base station and a radio resource management device for controlling the base station, or the like. The network device 102 may also include a relay station (relay device), an access point, a base station in a future 5G network, a base station in a future evolved PLMN network, an NR base station, or the like. The network device 102 may be a wearable device or a vehicle-mounted device. The network device 102 may also be a communication chip with a communication module.

For example, the network device 102 includes, but is not limited to, a next generation base station (gnodeB, gNB) in 5G, an evolved node B (eNB) in an LTE system, a radio network controller (RNC), a node B (NB) in a WCDMA system, a radio controller in a CRAN system, a basestation controller (BSC), a base transceiver station (BTS) in a GSM system or a CDMA system, a home base station (e.g., a home evolved node B, or a home node B, HNB), a baseband unit (BBU), a transmitting and receiving point (TRP), a transmitting point (TP), a mobile switching center, or the like.

In the C-DRX mechanism, the user equipment must monitor the PDCCH during the entire on duration, which wastes the energy consumption of the user equipment.

In view of the fact that in the C-DRX mechanism, the user equipment needs to continuously monitor the PDCCH during an entire on duration until the end of the on duration, and the operation mode of continuous monitoring of the PDCCH even if there is no scheduling data to be received in the on duration wastes the energy consumption of the user equipment, it is considered that the user equipment may not monitor the PDCCH and enter a sleep state when there is no scheduling data transmission in the on duration, that is, when the network device does not send scheduling data in the on duration. When the network device needs to send scheduling data, the user equipment is awakened first and then the scheduling data is sent. The method of awaking may adopt a wake-up signal (WUS), especially a low-power wake-up signal.

The user equipment that supports the low-power wake-up signal has a primary transceiver and a standby transceiver. If the user equipment receives a low-power WUS signal indicating wake-up, the primary receiver may be turned on for receiving and processing downlink signals, and if the low-power WUS signal is not received, or the low-power WUS signal indicates not to wake up, the user equipment may maintain a light sleep state of the primary receiver. If the primary receiver maintains the light sleep state, it may be awakened in real time by the low-power wake-up signal.

An embodiment of the present disclosure provides a method for sending and monitoring downlink control information. FIG. 3 is a flowchart of a method for sending and monitoring downlink control information according to an exemplary embodiment. As shown in FIG. 3, the method includes steps S301 to S303, specifically:

In step S301, when a user equipment determines that there is no downlink scheduling data transmission in an on duration in a C-DRX mode, the user equipment does not monitor a PDCCH, and enters a sleep state and monitors a low-power wake-up signal.

In some possible implementations, whether the user equipment is within the on duration in the C-DRX mode is determined according to a first timer, and the first timer is started in response to a start moment of the on duration in the C-DRX mode. For example, the first timer is a drx-onDuration Timer. Thus, when it is determined that the first timer is in a running state, it may be determined that the user equipment is in the on duration in the C-DRX mode, and when it is determined that the first timer is not in the running state, it may be determined that the user equipment is not in the on duration in the C-DRX mode.

It is determined whether there is downlink scheduling data transmission for the user equipment according to a second timer, and the second timer is started in response to receiving the scheduling data within the on duration of the C-DRX mode and is turned off after a set period of time. For example, the second timer is a drx-Inactivity Timer. Thus, it may be determined that there is downlink scheduling data transmission in the presence of a second timer in the running state, and it may be determined that there is no downlink scheduling data transmission in the absence of the second timer in the running state.

Therefore, determining that there is no downlink scheduling data transmission in the on duration in the C-DRX mode in step S301 includes determining that the first timer is in the running state and that there is no second timer in the running state.

In this implementation, the occasion in which there is no downlink scheduling data transmission in the on duration in the C-DRX mode determined in step S301 is one of the following two occasions.

The first occasion is an occasion in which no downlink scheduling data is transmitted after the downlink scheduling data has been received in the on duration in the C-DRX mode.

The second occasion is an occasion when the on duration in the C-DRX mode is just entered.

In some possible implementations, in order to more accurately determine the first occasion, determining that there is no downlink scheduling data transmission in the on duration in the connected discontinuous reception (C-DRX) mode in step S301 includes: determining that the scheduling data is not received in the on duration in the connected discontinuous reception (C-DRX) mode and that the scheduling data has been received in the on duration.

In order to determine that the scheduling data has been received in the on duration, it is necessary to record each second timer that has run in the on duration, and determine whether the scheduling data has been received in the on duration by determining whether the second timer has been run.

In some possible implementations, determining that there is no downlink scheduling data transmission in the on duration in the C-DRX mode in step S301 includes: determining that the PDCCH is started to be monitored when the on duration in the C-DRX mode is entered from an off duration of the C-DRX mode, and that no PDCCH is detected within a set period of time, thus the determined occasion is the occasion when the on duration is just entered.

In some possible implementations, determining that there is no downlink scheduling data transmission in the on duration in the C-DRX mode in step S301 includes starting monitoring the PDCCH when the first timer is started, and detecting no PDCCH within a set period of time.

In an example, the set period of time has been agreed in a protocol, and the user equipment determines the set period of time according to the protocol agreement.

In another example, the network device transmits configuration information to the user equipment, the configuration information is used to configure the set period of time, and the user equipment obtains the set period of time according to the configuration information.

In another example, the user equipment transmits indication information to the network device, the indication information is used to indicate at least one set period of time expected by the user equipment, and the network device transmits configuration information to the user equipment, where the configuration information is used to configure the set period of time, and the set period of time is one of the at least one set period of time expected.

In step S302, during the on duration in the C-DRX mode, the network device sends the low-power wake-up signal to the user equipment, and then sends the downlink scheduling data to the user equipment through the PDCCH.

In step S303, after receiving the low-power wake-up signal in the sleep state, the user equipment enters a wake-up state and monitors the PDCCH.

In the embodiment of the present disclosure, when there is no downlink scheduling data transmission in the on duration in the C-DRX mode, the user equipment does not monitor the PDCCH, and enters the sleep state and monitors the low-power wake-up signal. The low-power wake-up signal is used to wake up the user equipment only when the network device needs to send downlink scheduling information. Compared with the mode in which the user equipment continuously monitors the PDCCH during the on duration in the C-DRX mode, the user equipment may sleep during the period in which the PDCCH is not required to be monitored, thereby effectively saving the energy consumption of the user equipment.

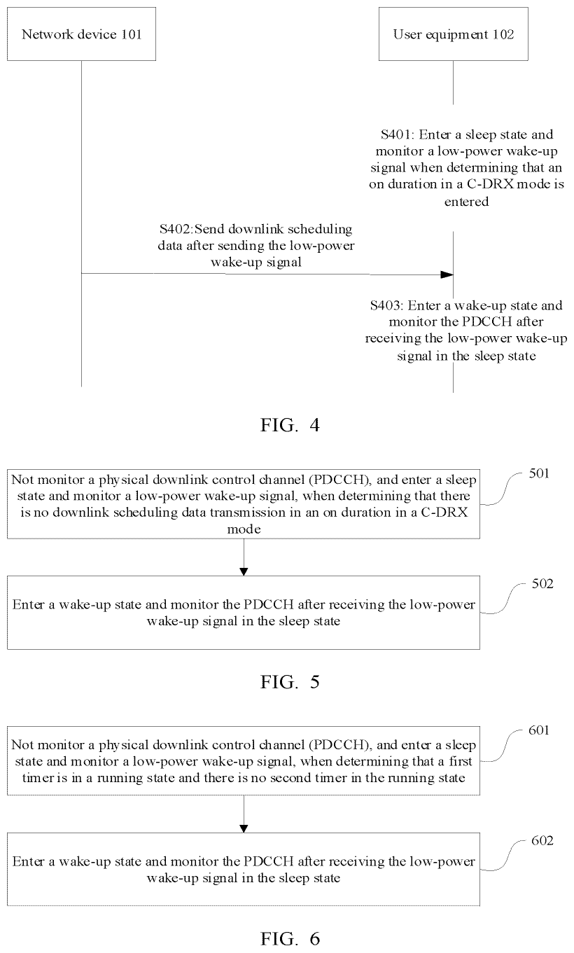

An embodiment of the present disclosure provides a method for sending and monitoring downlink control information. FIG. 4 is a flowchart of a method for sending and monitoring downlink control information according to an exemplary embodiment. As shown in FIG. 4, the method includes steps S401 to S402, specifically:

In step S401, when a user equipment determines to enter an on duration in a C-DRX mode, the user equipment enters a sleep state and monitors a low-power wake-up signal.

In some possible implementations, a manner for the user equipment to determine that it enters the on duration in the C-DRX mode is to determine that a first timer is started, where the first timer is started in response to a start moment of the on duration in the C-DRX mode. For example, the first timer is drx-onDurationTimer.

In step S402, the network device sends the low-power wake-up signal to the user equipment and then sends the downlink scheduling data to the user equipment through the PDCCH.

In step S403, after receiving the low-power wake-up signal in the sleep state, the user equipment enters a wake-up state and monitor the PDCCH.

In the embodiment of the present disclosure, the user equipment directly enters the sleep state and monitor the low-power wake-up signal while entering the on duration in the C-DRX mode, without considering whether to monitor the PDCCH and whether the PDCCH is detected. It is suitable for an application scenario in which the network device does not send the downlink scheduling data in the early stage of the on duration in the C-DRX mode, and energy consumption of the user equipment can be saved.

An embodiment of the present disclosure provides a method for monitoring downlink control information, which is performed by a user equipment. FIG. 5 is a flowchart of a method for monitoring downlink control information according to an exemplary embodiment. As shown in FIG. 5, the method includes steps S501 to S502, specifically:

In step S501, when it is determined that there is no downlink scheduling data transmission in an on duration in a C-DRX mode, a PDCCH is not monitored, and a sleep state is entered and a low-power wake-up signal is monitored.

In step S502, after receiving the low-power wake-up signal in the sleep state, a wake-up state is entered and the PDCCH is monitored.

In the embodiment of the present disclosure, when there is no downlink scheduling data transmission in the on duration in the C-DRX mode, the user equipment does not monitor the PDCCH, and enters the sleep state and monitors the low-power wake-up signal. The low-power wake-up signal is used to wake up the user equipment only when the network device needs to send downlink scheduling information. Compared with the mode in which the user equipment continuously monitors the PDCCH during the on duration in the C-DRX mode, the user equipment may sleep during the period in which the PDCCH is not required to be monitored, thereby effectively saving the energy consumption of the user equipment.

An embodiment of the present disclosure provides a method for monitoring downlink control information, which is performed by a user equipment. FIG. 6 is a flowchart of a method for monitoring downlink control information according to an exemplary embodiment. As shown in FIG. 6, the method includes steps S601 to S602, specifically:

In step S601, when it is determined that a first timer is in a running state and there is no second timer in the running state, a PDCCH is not monitored, and a sleep state is entered and a low-power wake-up signal is monitored.

In step S602, after receiving the low-power wake-up signal in the sleep state, a wake-up state is entered and the PDCCH is monitored.

In some possible implementations, whether the user equipment is within the on duration in the C-DRX mode may be determined according to the first timer, and the first timer is started in response to a start moment of the on duration in the C-DRX mode. For example, the first timer is a drx-onDuration Timer. Thus, when it is determined that the first timer is in the running state, it may be determined that the user equipment is in the on duration in the C-DRX mode, and when it is determined that the first timer is not in the running state, it may be determined that the user equipment is not in the on duration in the C-DRX mode.

It is determined whether there is downlink scheduling data transmission for the user equipment according to the second timer, and the second timer is started in response to receiving the scheduling data within the on duration of the C-DRX mode and is turned off after a set period of time. For example, the second timer is a drx-Inactivity Timer. Thus, it may be determined that there is downlink scheduling data transmission in the presence of a second timer in the running state, and it may be determined that there is no downlink scheduling data transmission in the absence of the second timer in the running state.

In this implementation, the occasion in which there is no downlink scheduling data transmission in the on duration in the C-DRX mode determined in step S601 is one of the following two occasions.

The first occasion is an occasion in which no downlink scheduling data is transmitted after the downlink scheduling data has been received in the on duration in the C-DRX mode.

The second occasion is an occasion when the on duration in the C-DRX mode is just entered.

In some possible implementations, in order to more accurately determine the first timing, determining that there is no downlink scheduling data transmission in the on duration in the connected discontinuous reception (C-DRX) mode in step S601 includes determining that the scheduling data is not received in the on duration in the connected discontinuous reception (C-DRX) mode and that the scheduling data has been received in the on duration.

In order to determine that the scheduling data has been received in the on duration, it is necessary to record each second timer that has run in the on duration, and determine whether the scheduling data has been received in the on duration according to whether the second timer has been run.

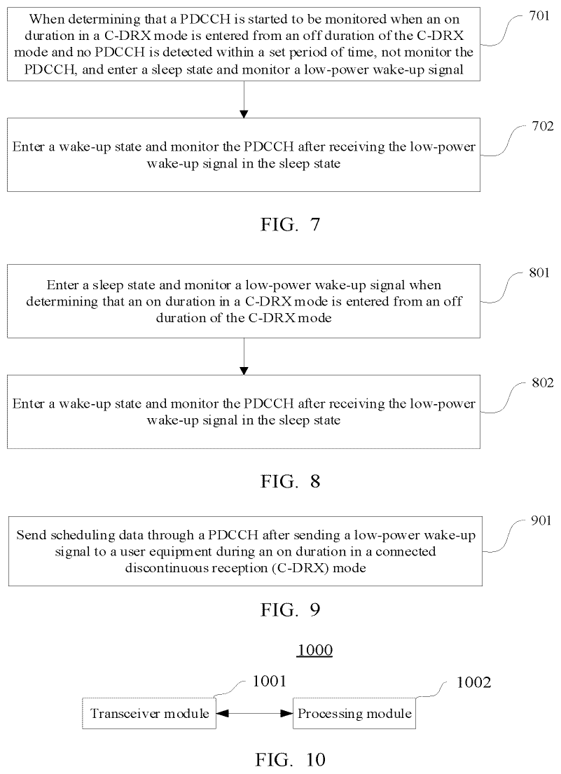

An embodiment of the present disclosure provides a method for monitoring downlink control information, which is performed by a user equipment. FIG. 7 is a flowchart of a method for monitoring downlink control information according to an exemplary embodiment. As shown in FIG. 7, the method includes steps S701 to S702, specifically:

In step S701, when determining that a PDCCH is started to be monitored when an on duration in a C-DRX mode is entered from an off duration of the C-DRX mode and no PDCCH is detected within a set period of time, the PDCCH is not monitored, and a sleep state is entered and a low-power wake-up signal is monitored.

In step S702, after receiving the low-power wake-up signal in the sleep state, a wake-up state is entered and the PDCCH is monitored.

The occasion determined in step S701 is an occasion when the on duration is just entered.

In some possible implementations, in the step S701, the starting monitoring the PDCCH when it is determined that the on duration in the C-DRX mode is entered from the off duration of the C-DRX mode includes starting monitoring the PDCCH when a first timer is started. In an example, the first timer is drx-onDuration Timer.

In an example, the set period of time is agreed in a protocol, and the user equipment determines the set period of time according to the protocol agreement.

In another example, the network device transmits configuration information to the user equipment, the configuration information is used to configure the set period of time, and the user equipment obtains the set period of time according to the configuration information.

In another example, the user equipment transmits indication information to the network device, the indication information is used to indicate at least one set period of time expected by the user equipment, and the network device transmits configuration information to the user equipment, where the configuration information is used to configure the set period of time, and the set period of time is one of the at least one set period of time expected.

An embodiment of the present disclosure provides a method for monitoring downlink control information, which is performed by a user equipment. FIG. 8 is a flowchart of a method for monitoring downlink control information according to an exemplary embodiment. As shown in FIG. 8, the method includes steps S801 to S802, specifically:

In step S801, a sleep state is entered and a low-power wake-up signal is monitored when it is determined that an on duration in a C-DRX mode is entered from an off duration of the C-DRX mode.

In step S802, after receiving the low-power wake-up signal in the sleep state, a wake-up state is entered and the PDCCH is monitored.

In some possible implementations, in step S801, the entering the sleep state and monitoring the low-power wake-up signal when it is determined that the on duration in the C-DRX mode is entered from the off duration of the C-DRX mode includes entering the sleep state and monitoring the low-power wake-up signal when the first timer is started. In an example, the first timer is drx-onDuration Timer.

In the embodiment of the present disclosure, the user equipment directly enters the sleep state and monitor the low-power wake-up signal while entering the on duration in the C-DRX mode, without considering whether to monitor the PDCCH and whether the PDCCH is detected. It is suitable for an application scenario in which the network device does not send the downlink scheduling data in the early stage of the on duration in the C-DRX mode, and energy consumption of the user equipment can be saved.

An embodiment of the present disclosure provides a method for sending downlink control information, which is performed by a network device. FIG. 9 is a flowchart of a method for sending downlink control information according to an exemplary embodiment. As shown in FIG. 9, the method includes step S901, specifically:

In step S901, during an on duration in a C-DRX mode, scheduling data is sent through a PDCCH after a low-power wake-up signal is sent to a user equipment.

In the embodiment of the present disclosure, the user equipment enters a sleep state when there is no downlink scheduling data transmission during the on duration in the C-DRX mode, and the network device sends the low-power wake-up signal to wake up the user equipment before it needs to send the scheduling data through the PDCCH, thereby ensuring normal transmission and reception of the scheduling data.

Based on the same concept as the above method embodiments, an embodiment of the present disclosure further provides a communication apparatus, which may have the function of the user equipment 102 in the above method embodiments, and is configured to execute the steps executed by the user equipment 102 provided in the above embodiments. This function may be implemented by hardware, or may be implemented by software or implemented by hardware executing corresponding software. The hardware or software includes one or more modules corresponding to the functions as described above.

In one possible implementation, the communication apparatus 1000 as shown in FIG. 10 may serve as the user equipment 102 according to the above method embodiments, and perform the steps performed by the user equipment 102 in one of the above method embodiments.

The communication apparatus 1000 includes a transceiver module 1001 and a processing module 1002.

The transceiver module 1001 is configured to not monitor a PDCCH and monitor a low-power wake-up signal when it is determined that there is no downlink scheduling data transmission in an on duration in a connected discontinuous reception (C-DRX) mode;

The processing module 1002 is configured to enter a sleep state when it is determined that there is no downlink scheduling data transmission in the on duration in the C-DRX mode.

In some possible implementations, the transceiver module 1001 is further configured to enter a wake-up state and monitor the PDCCH after receiving the low-power wake-up signal in the sleep state.

In some possible implementations, the processing module 1002 is further configured to determine that there is no downlink scheduling data transmission in the on duration in the connected discontinuous reception (C-DRX) mode in the following way: determining that a first timer is in a running state and there is no second timer in the running state, where the first timer is started in response to a start moment of the on duration of the C-DRX mode, and the second timer is started in response to receiving scheduling data within the on duration of the C-DRX mode and is turned off after a set period of time.

In some possible implementations, the processing module 1002 is further configured to determine that there is no downlink scheduling data transmission in the on duration in the C-DRX mode in the following way: determining that the PDCCH is stared to be monitored when the on duration in the C-DRX mode is entered from an off duration of the C-DRX mode, and that no PDCCH is detected within a set period of time.

In some possible implementations, the processing module 1002 is further configured to determine the set period of time according to a protocol.

In some possible implementations, the processing module 1002 is further configured to receive configuration information sent by a network device, and the configuration information is used to configure the set period of time.

When the communication apparatus is the user equipment 102, the structure thereof may also be as shown in FIG. 11.

FIG. 11 is a block diagram of an apparatus 1100 for monitoring downlink control information according to an exemplary embodiment. For example, the apparatus 1100 may be a mobile phone, a computer, a digital broadcast terminal, a messaging device, a game console, a tablet device, a medical device, a fitness device, a personal digital assistant, or the like.

Referring to FIG. 11, the apparatus 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 generally controls overall operations of the apparatus 1100, such as operations associated with display, telephone calls, data communications, camera operations, and recording operations. The processing component 1102 may include one or more processors 1120 to execute instructions to complete all or some of the steps of the methods as described above. Further, the processing component 1102 may include one or more modules that facilitate interaction between the processing component 1102 and other components. For example, the processing component 1102 may include a multimedia module to facilitate interaction between the multimedia component 1108 and the processing component 1102.

The memory 1104 is configured to store various types of data to support operation at the apparatus 1100. Examples of such data include instructions for any application or method operating on the apparatus 1100, contact data, phone book data, messages, pictures, videos, and the like. The memory 1104 may be implemented by any type of volatile or non-volatile storage device, or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk.

The power component 1106 provides power to various components of the apparatus 1100. The power components 1106 may include a power management system, one or more power sources, and other components associated with generating, managing, and distributing power for the apparatus 1100.

The multimedia component 1108 includes a screen that provides an output interface between the apparatus 1100 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensor may sense not only the boundary of the touch or swipe action, but also the duration and pressure associated with the touch or swipe operation. In some embodiments, the multimedia component 1108 includes a front camera and/or a rear camera. When the apparatus 1100 is in an operating mode, such as a shooting mode or a video mode, the front camera and/or the rear camera may receive external multimedia data. Each of the front camera and the rear camera may be a fixed optical lens system or have focal length and optical zoom capability.

The audio component 1110 is configured to output and/or input audio signals. For example, the audio component 1110 includes a microphone (MIC) configured to receive external audio signals when the apparatus 1100 is in an operating mode, such as a call mode, a recording mode, and a speech recognition mode. The received audio signals may be further stored in the memory 1104 or transmitted via the communication component 1116. In some embodiments, the audio component 1110 further includes a speaker for outputting an audio signal.

The I/O interface 1112 provides an interface between the processing component 1102 and a peripheral interface module, such as keyboards, click wheels, buttons, or the like. These buttons may include, but are not limited to, a home button, a volume button, a start button, and a lock button.

The sensor assembly 1114 includes one or more sensors for providing a state assessment of various aspects of the apparatus 1100. For example, the sensor assembly 1114 may detect an on/off state of the apparatus 1100, and a relative positioning of components, such as a display and a keypad of the apparatus 1100. The sensor assembly 1114 may also detect changes in the position of the apparatus 1100 or one of the components of the apparatus 1100, the presence or absence of user contact with the apparatus 1100, the orientation or acceleration/deceleration of the apparatus 1100, and changes in the temperature of the apparatus 1100. The sensor assembly 1114 may include a proximity sensor configured to detect the presence of an adjacent object in the absence of any physical contact. The sensor assembly 1114 may also include a light sensor, such as a CMOS or CCD image sensor, for use in imaging applications. In some embodiments, the sensor assembly 1114 may further include an acceleration sensor, a gyroscope sensor, a magnetic sensor, a pressure sensor, or a temperature sensor.

The communication component 1116 is configured to facilitate wired or wireless communication between the apparatus 1100 and other devices. The apparatus 1100 may access a wireless network based on a communication standard, such as WiFi, 4G or 5G, or a combination thereof. In one exemplary embodiment, the communication component 1116 receives a broadcast signal or broadcast-related information from an external broadcast management system via a broadcast channel. In one exemplary embodiment, the communication component 1116 further includes a near-field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an exemplary embodiment, the apparatus 1100 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the methods as described above.

In an exemplary embodiment, a non-transitory computer-readable storage medium including instructions, for example, the memory 1104 including instructions, is further provided. The above instructions may be executed by the processor 1120 of the apparatus 1100 to accomplish the methods as described above. For example, the non-transitory computer-readable storage medium may be a ROM, a random access memory (RAM), a CD-ROM, a magnetic tape, a floppy disk, an optical data storage device, and the like.

Based on the same concept as the above method embodiments, an embodiment of the present disclosure further provides a communication apparatus, which may have the function of the network device 101 in the above method embodiments, and is configured to execute the steps executed by the network device 101 provided in the above embodiments. This function may be implemented by hardware, or may be implemented by software or implemented by hardware executing corresponding software. The hardware or software includes one or more modules corresponding to the functions as described above.

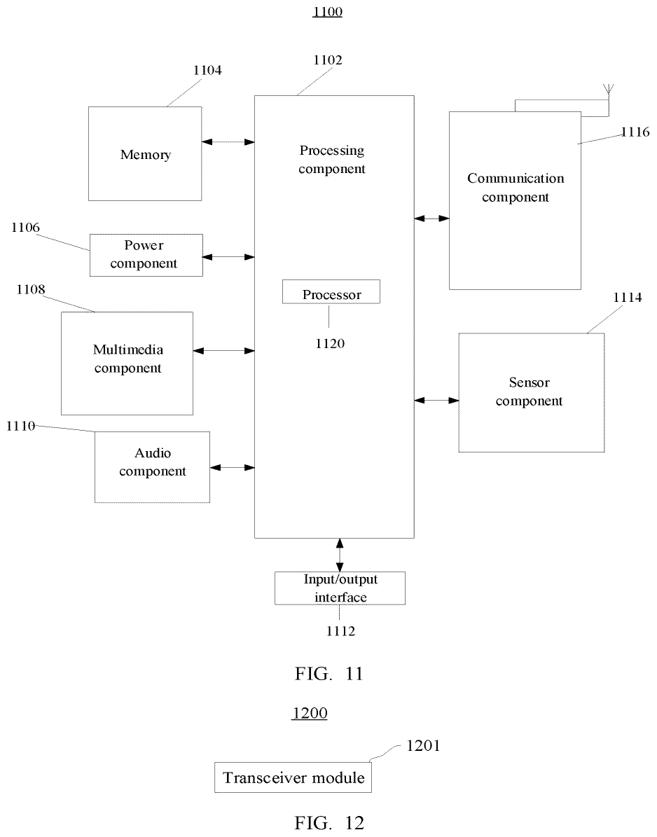

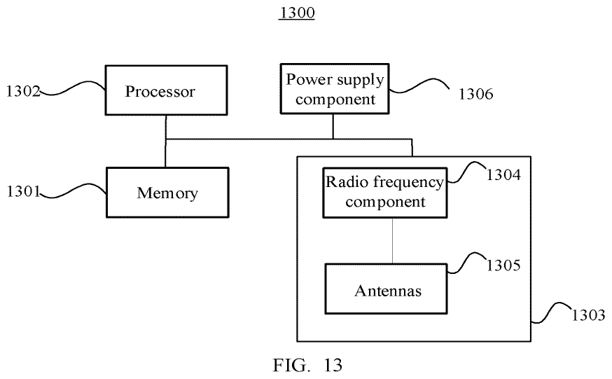

In one possible implementation, the communication apparatus 1200 as shown in FIG. 12 may be the network device 101 involved in the above method embodiments, and may execute the steps performed by the network device 101 in the above method embodiments.

The communication apparatus 1200 as shown in FIG. 12 includes a transceiver module 1201 for performing the steps performed by the network device 101 in the above method embodiments.

The transceiver module 1201 is configured to send scheduling data through the PDCCH after sending the low-power wake-up signal to the user equipment during the on duration in the connected discontinuous reception (C-DRX) mode.

When the communication apparatus is the network device 101, the structure thereof may also be as shown in FIG. 13. The configuration of the communication apparatus will be described by taking the network device 101 as a base station as an example. As shown in FIG. 13, the apparatus 1300 includes a memory 1301, a processor 1302, a transceiver component 1303, and a power supply component 1306. The memory 1301 is coupled to the processor 1302, and may be used to store programs and data necessary for the communication apparatus 1300 to implement various functions. The processor 1302 is configured to support the communication apparatus 1300 to perform corresponding functions in the above methods, and the functions may be realized by calling a program stored in the memory 1301. The transceiver component 1303 may be a wireless transceiver and may be used to support the communication apparatus 1300 to receive signaling and/or data and transmit signaling and/or data over a wireless air interface. The transceiver component 1303 may also be referred to as a transceiver unit or a communication unit, and may include a radio frequency component 1304, which may be a remote radio unit (RRU) specifically used for transmitting radio frequency signals and conversion between radio frequency signals and baseband signals, and one or more antennas 1305 specifically used for radiating and receiving radio frequency signals. When the communication apparatus 1300 needs to transmit data, the processor 1302 may perform baseband processing on the data to be transmitted, and then output a baseband signal to a radio frequency unit, and the radio frequency unit performs radio processing on the baseband signal and then transmits the radio frequency signal in the form of electromagnetic waves through an antenna. When data is transmitted to the communication apparatus 1300, the radio frequency unit receives the radio frequency signal through the antenna, converts the radio frequency signal into a baseband signal, and outputs the baseband signal to the processor 1302, and the processor 1302 converts the baseband signal into data and processes the data.

Other implementations of the embodiments of the present disclosure will readily occur to those skilled in the art upon consideration of the specification and practice of the disclosure disclosed herein. The present application is intended to cover any modifications, uses, or adaptations of the embodiments of the present disclosure, which follow the general principles of the embodiments of the present disclosure and include common knowledge or conventional technical means in the technical field not disclosed in the present disclosure. The specification and embodiments are to be regarded as exemplary only, and the true scope and spirit of the embodiments of the present disclosure are indicated by the following claims.

It should be understood that the embodiments of the present disclosure are not limited to the precise structures described above and illustrated in the accompanying drawings, and various modifications and changes may be made without departing from the scope thereof. The scope of embodiments of the present disclosure is limited only by the appended claims.

### Industrial Practicality

The power consumption of the user equipment is saved.

1. A method for monitoring downlink control information, performed by a user equipment, the method comprising:
in response to determining that no downlink scheduling data transmission exists in an on duration in a connected discontinuous reception (C-DRX) mode, not monitoring a physical downlink control channel (PDCCH), and entering a sleep state and monitoring a low-power wake-up signal.

2. The method for monitoring downlink control information according to claim 1, further comprising:
after receiving the low-power wake-up signal in the sleep state, entering a wake-up state and monitoring the PDCCH.

3. The method for monitoring downlink control information according to claim 1, wherein determining that no downlink scheduling data transmission exists in the on duration in the C-DRX mode comprises:
determining that a first timer is in a running state and no second timer in the running state exists, wherein the first timer is started in response to a start moment of the on duration of the C-DRX mode, and the second timer is started in response to receiving scheduling data within the on duration of the C-DRX mode and is turned off after a set period of time.

4. The method for monitoring downlink control information according to claim 3, wherein the first timer is a drx-onDurationTimer, and the second timer is a drx-Inactivity Timer.

5. The method for monitoring downlink control information according to claim 1, wherein determining that no downlink scheduling data transmission exists in the on duration in the C-DRX mode comprises:
determining that the PDCCH is started to be monitored when the on duration in the C-DRX mode is entered from an off duration of the C-DRX mode, and that no PDCCH is detected within a set period of time.

6. The method for monitoring downlink control information according to claim 3, further comprising:
determining the set period of time according to a protocol; or
receiving configuration information sent by a network device, wherein the configuration information is used to configure the set period of time.

7. A method for sending downlink control information, performed by a network device, the method comprising:
during an on duration in a connected discontinuous reception (C-DRX) mode, sending scheduling data through a physical downlink control channel (PDCCH) after sending a low-power wake-up signal to a user equipment.

8-9. (canceled)

10. An electronic device comprising a processor and a memory, wherein
the memory is configured to store a computer program; and
the processor is configured to execute the computer program to:
in response to determining that no downlink scheduling data transmission exists in an on duration in a connected discontinuous reception (C-DRX) mode, not monitor a physical downlink control channel (PDCCH), and enter a sleep state and monitor a low-power wake-up signal.

11. An electronic device comprising a processor and a memory, wherein the memory is configured to store a computer program; and
the processor is configured to execute the computer program to implement the method according to claim 7.

12. non-transitory_computer-readable storage medium having instructions stored therein that, when called for execution on a computer, cause the computer to perform the method according to claim 1.

13. A non-transitory_computer-readable storage medium having instructions stored therein that, when called for execution on a computer, cause the computer to perform the method according to claim 7.

14. The method for monitoring downlink control information according to claim 5, further comprising:
determining the set period of time according to a protocol; or
receiving configuration information sent by a network device, wherein the configuration information is used to configure the set period of time.

15. The electronic device according to claim 10, wherein the processor is further configured to execute the computer program to:
after receiving the low-power wake-up signal in the sleep state, enter a wake-up state and monitoring the PDCCH.

16. The electronic device according to claim 10, wherein the processor is further configured to execute the computer program to:
determine that a first timer is in a running state and no second timer in the running state exists, wherein the first timer is started in response to a start moment of the on duration of the C-DRX mode, and the second timer is started in response to receiving scheduling data within the on duration of the C-DRX mode and is turned off after a set period of time.

17. The electronic device according to claim 16, wherein the first timer is a drx-onDuration Timer, and the second timer is a drx-Inactivity Timer.

18. The electronic device according to claim 10, wherein the processor is further configured to execute the computer program to:
determine that the PDCCH is started to be monitored when the on duration in the C-DRX mode is entered from an off duration of the C-DRX mode, and that no PDCCH is detected within a set period of time.

19. The electronic device according to claim 16, wherein the processor is further configured to execute the computer program to:
determine the set period of time according to a protocol; or receive configuration information sent by a network device, wherein the configuration information is used to configure the set period of time.

20. The electronic device according to claim 18, wherein the processor is further configured to execute the computer program to:
determine the set period of time according to a protocol; or
receive configuration information sent by a network device, wherein the configuration information is used to configure the set period of time.
